(19) United States
(12) Patent Application Publication
(10) Pub. No.: US 2003/0233661 A1
(43) Pub. Date: Dec. 18, 2003

(54) Configurable system for inserting multimedia content into a broadcast stream

(76) Inventors: David Landis Fisher, Tega Cay, SC (US); Bryan A. Blair, Fort Mill, SC (US)

Correspondence Address: DAVID L. FISHER, CARDSMART TECHNOLOGIES INC, 1140 MOLOKAI DRIVE, TEGA CAY, SC, 29708, US

(21) Appl. No.: 10/445,665

(22) Filed: May 28, 2003

Related U.S. Application Data
(60) Provisional application No. 60/384,927, filed on Jun. 3, 2002.

(51) Int. Cl. H04N 7/173; H04N 5/445

(52) U.S. Cl. 725/90; 348/563

(57) ABSTRACT

This invention discloses a system for processing multimedia content from multiple sources. The system can adjust the viewable size of a video stream as well as control how additional customized graphics and text are integrated together to produce a single multimedia output stream. The layout and content of the output is completely configurable to accommodate text (ex: notices, scrollers, tickers), images (ex: logos, advertisements, banners), audio, and streaming video (ex: movies, cable, satellite, games).

Configuration tools are provided to control how the insertion content rendered. Specifically, an MS Windows application takes the user through the configuration process to setup the attributes of the stored insertion content and how it should be merged with the streaming multimedia input. Once the stored insertion content and streaming input are merged a combined output in NTSC format for viewing on a television or projection unit.

Related Applications

| | | |
|---|---|---|
| 6,381,362 | Deshpande, et al | April 2002 |
| 6,243,104 | Murray | June 2001 |
| 6,184,937 | Williams, et al | February 2001 |
| 6,061,659 | Murray | May 2000 |
| 5,731,846 | Kreitman, et al. | March 1998 |
| 5,491,517 | Kreitman, et al | February 1996 |
| 5,264,933 | Rosser, et al | November 1993 |

### FEDERAL SPONSORED R&D

None.

### FIELD OF THE INVENTION

This invention relates to a system that can create, alter, and/or dynamically replace the form and substance of a broadcast signal.

### BACKGROUND OF THE INVENTION

Video and audio broadcasts can be sourced from many locations including cable, satellite, radio, or playback devices such as VCR, CD/DVD, or computers. Typically the signal is sent directly to a monitor (ex. television or speakers). At this point of projection there exists only limited mechanisms for customizing the resulting output picture such as “picture-in-picture” or display of subtitles.

### DESCRIPTION OF THE PRIOR ART

To date no system exists that allows multiple media contents, such as computer generated graphics, audio, and video to be combined easily and inexpensively in a predetermined manner by non-technical personnel at the point where the video/audio signal is actually projected.

### SUMMARY OF THE INVENTION

It is therefore an object of the present invention to enable the integration of multimedia content into a broadcast stream.

A first aspect of the present application consists of correctly receiving and interpreting an input audio/video signal and then manipulating its attributes to accommodate supplemental text, graphics, or video. This supplemental multimedia is hereafter referred to as “insertion content”.

A second aspect is to retrieve and display the insertion content that has been stored in memory. This process would be on-demand or as required by timing parameters defined as part of the configuration settings. As such, the device memory stores not only the actual content but also its properties such as scheduling and screen position.

A third aspect of the present application is to provide the means by which the input signal can be merged with the stored multimedia insertion content into a single output.

A fourth aspect of the present application is to provide a means to selectively display and play back the stored multimedia insertion content from a playback list.

A fifth aspect of the present application is to control the integration of the input signal and the insertion content so that the stored insertion content can be placed transparently on top, beside, below, or in place of the input video.

A sixth aspect of the present application is a software tool to configure the integration and display of the audio/video signal and stored multimedia content.

These and other aspects of the present application will become more readily apparent from the attached drawings and detailed description given below,

### BRIEF DESCRIPTION OF THE DRAWINGS

FIG. 1 illustrates the procedure for taking the streaming audio/video media and the user modifiable graphics and scrolling text and graphics and merging them into a single usable multimedia output.

FIG. 2 illustrates the parameters that are configurable by the end user to change the look and feel of the final merged multimedia output.

FIG. 3 illustrates a sample of the user modifiable configuration data that is generated by the MS Windows configuration tool.

FIG. 4 illustrates a preferred embodiment of the system.

The present invention will become more fully understood from the detailed description given below. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

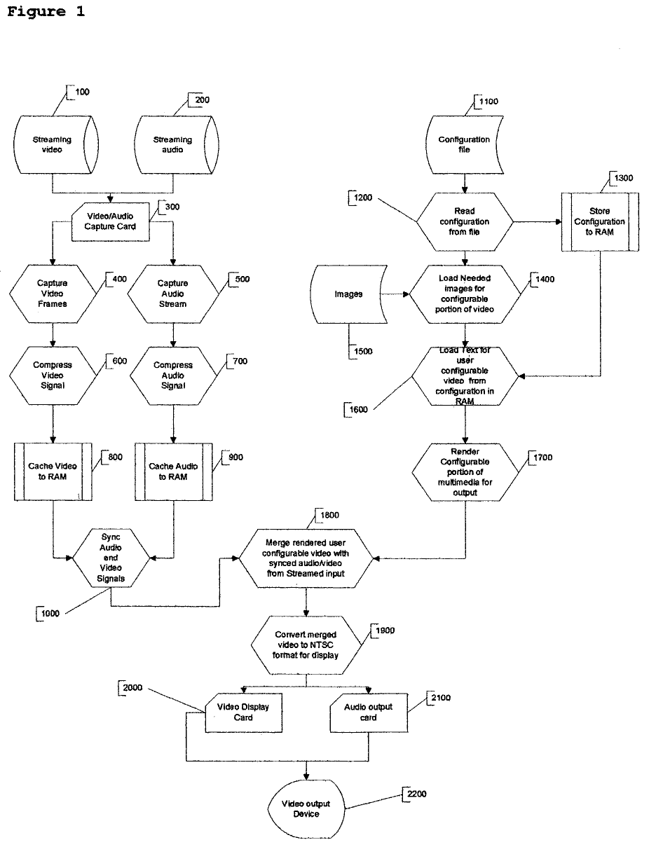

This system enables a broadcast stream to be configured for composition and presentation. Customized messaging such as advertising or consumer information can then be integrated into the stream. This may take the form of scrolling/fading/sliding text, logos, or graphics. FIG. 1 illustrates that the system can capture source video content 100 and source audio content 200 from a TV/cable/VCR/DVD/computer signal via an audio/video capture card 300. The captured video frames 400 are compressed by a video processor 600 and are cached to RAM 800 for future playback. The captured audio stream 500 is compressed by an audio processor 700 and is cached to RAM 900 for future playback. The user configuration file 1100 is read 1200 and stored in RAM 1300 for use. Stored static images 1500 are loaded 1400 for the user configurable portion of the multimedia stream. Text for scrolling and static text messages are loaded 1600 from the configuration stored in RAM 1300. The static images 1500 that were loaded into memory 1400 and the text for scrolling and static text messages that were loaded into memory 1600 from the configuration stored in memory 1300 are rendered into the user configurable multimedia portion for output 1700 by a display processor. The synchronized audio/video stream signals 1000 and the rendered user configurable multimedia output 1700 are merged into one signal for output 1800. The video portion of the output signal is finalized by the video display card 2000 and is sent on in NTSC format to the Multimedia Display Device 2200. The audio portion of the output signal is converted to an analog signal by the audio output card 2100 and is forwarded to the Multimedia Display Device 2200 and is played simultaneously with the video portion of the output signal.

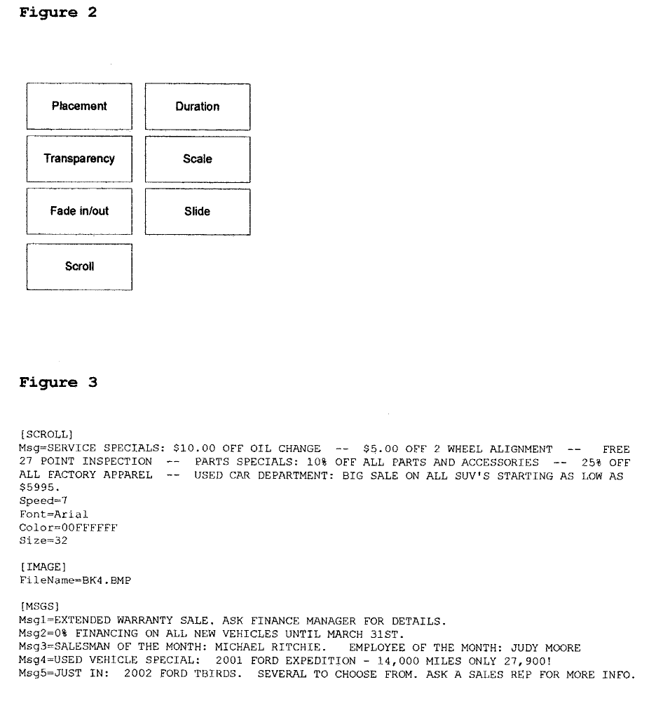

The insertion content can be customized with many effects including scrolling/fading/sliding text, logos, or graphics. Other configuration options include event scheduling, position, transparency, etc. FIG. 2 illustrates some of the possible effects.

These effects and presentation sequencing are completely configurable through a software interface. FIG. 3 shows a sample configuration file that defines these parameters. Configuration changes are stored on a separate media or in a separate location on the video device's non-volatile storage media. A sampling process checks every few seconds for the presence of removable media or a change to the directory on the video device's non-volatile storage media that the configuration file is stored in. Detection of this media or a change to the directory that the configuration file is stored in will prompt the date/time stamp of the configuration file to be read and compared against the previously stored configuration.

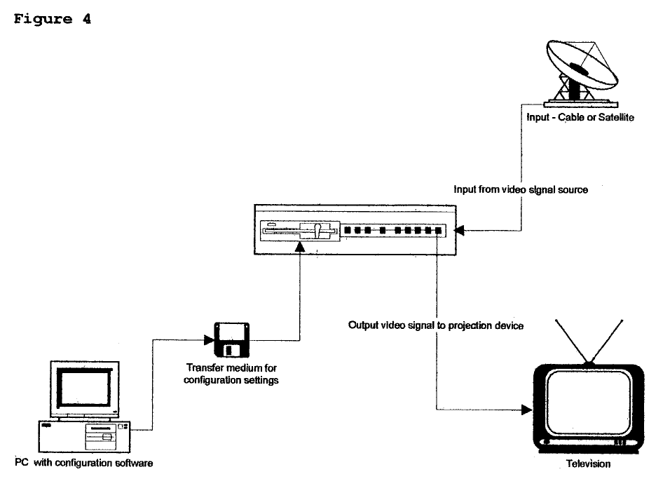

FIG. 4 shows the flow of a typical site setup whereby a configuration setup is created on a PC with the configuration software and transferred to the video device via removable media. In FIG. 4 the media is shown as a floppy disk however it could be a CD/ROM, DVD, ZIP Disk, LS-120 disk or be transferred over a TCP/IP network. Once the configuration is loaded the video device reads the configuration and makes changes to formatting, text messages, graphics, and video settings as specified in the configuration file. The changes are then merged with the video feed from a video source such as cable, satellite, DVD, or Video Tape and are sent to the monitor in NTSC format as a merged feed for display.

In one embodiment the input signal is a TV broadcast delivered by cable or satellite. This device shrinks the television broadcast by 20% and moves it to the top right-hand side of the television screen. This in-turn creates ample screen space that can be used to advertise products, services or simply to provide customer information. Specifically, there is space to add a scrolling message at the bottom of the screen and a transitional message on the left side of the screen.

In another embodiment, the device manages a play list where multiple contents are stored in the device's memory and replayed according to a specified schedule. For example, video clips could be played in sequence with advertisements creating a customized broadcast.

In another embodiment, the input video signal is selectively replaced with a secondary video stream. The device can toggle between input signal and streamed content as stored in the device memory. This would produce a broadcast that was a combination of live feed and stored clips. An example might be to cycle through 15 minutes of news headlines followed by 15 minutes of supplemental video and advertisements that play from the device memory.

What is claimed is:

1) Method for integrating multimedia content into a broadcast stream consisting of the following steps:
1. Dynamically optimize the audio/video broadcast stream immediately before it is sent to a monitor for playback. This step includes any necessary modification of the stream so as to prepare it for the insertion of predetermined content.
2. Retrieve from a stored memory desired insertion content comprising of logos, graphics, video, static text, scrolling text, and/or audio.
3. Retrieve from a stored memory any attributes needed to properly render the insertion content. These define the appearance, position, speed, and scheduling for each insertion content item.
4. Combine optimized stream from step 1 with insertion content from step 2 according to rules in step 3.
5. The single merged output stream from step 4 is then sent to a monitor such as a speaker or television.

2) Method of claim 1 to include input signals from satellite, cable, or any video playback device with the ability of outputting a video signal.

3) Method of claim 1 to include audio input such as broadcast radio, or prerecorded audio.

4) Method of claim 1 where the optimization of broadcast stream could include: refining the stream through channel tuning, signal filtering, and changing the aspect ratio.

5) Method of claim 1 where the insertion content attributes and associated rules are completely configurable by non-technical personnel.

6) Method of claim 1 such that when the input stream is video, the insertion content can be integrated so that it is placed transparently on top, beside, below, or in place of the input video stream.

7) System comprising of a software tool to be used for configuring the insertion content as introduced in claim 1. This software tool will enable the configuration of the following:
1. Preprocessing and optimization of the input stream.
2. Properties for scheduling and rendering of the insertion content.
3. Settings for how the input stream and insertion content should be merged.

8) System of claim 7 where the configuration updates can be transferred from a PC via removable media or TCP/IP network.
